(19) United States
(12) Patent Application Publication
(10) Pub. No.: US 2026/0143161 A1
(43) Pub. Date: May 21, 2026

(54) INTRA BLOCK COPY WITH REFINEMENT

(71) Applicant: APPLE INC., Cupertino, CA (US)

(72) Inventors: Aki KUUSELA, Palo Alto, CA (US); Yeqing WU, Cupertino, CA (US); Yunfei ZHENG, Santa Clara, CA (US); Xin ZHAO, San Jose, CA (US); Yixin DU, Cupertino, CA (US); Van Luong PHAM, San Diego, CA (US); Alexandros TOURAPIS, Los Gatos, CA (US)

(21) Appl. No.: 19/360,133

(22) Filed: Oct. 16, 2025

Related U.S. Application Data
(60) Provisional application No. 63/722,006, filed on Nov. 18, 2024.

(51) Int. Cl. H04N 19/593; H04N 19/105; H04N 19/117; H04N 19/136; H04N 19/172; H04N 19/174; H04N 19/176

(52) U.S. Cl. CPC H04N 19/593; H04N 19/105; H04N 19/117; H04N 19/136; H04N 19/172; H04N 19/174; H04N 19/176

(57) ABSTRACT

Techniques are disclosed to code and decode video content in a resource-conserved manner. If a first embodiment, coding units containing IBC-coded video may be decoded first to generate decoded but unfiltered video, which may be made available as a prediction reference for later coding and decoding operations. Coding units for the IBC video also may be filtered and made available as a prediction reference for the later coding and decoding operations. It is expected that the unfiltered video and the filtered video may be generated in a pipelined manner that conserves resources in a computer system that are expended to write and read the video to off-processor storage locations. In another embodiment, coding parameters of coded video may be predicted from coding parameters of previously-coded video belonging at locations temporally removed from video that is being decoded.

### CLAIM FOR PRIORITY

The present application benefits from priority of U.S. patent application Ser. No. 63/722,006, entitled “Intra Block Copy With Refinement” and filed Nov. 18, 2024, the disclosures of which are incorporated herein in its entirety.

### BACKGROUND

The present disclosure relates to video coding and decoding systems.

Modern consumer electronic devices often support the exchange of video between them. The video may be “natural” video, which represents a local environment as captured by a camera system or it may be “synthetic” video, which may be generated by an application executing on the device. No matter the source, it often is required to apply bandwidth compression operations to the video to facilitate communication over bandwidth-constrained networks. These devices often perform their compression operations according to inter-operability standards that define how compression operations are to be performed and how the compressed data is to be represented. In this manner, devices that decompress the compressed video will be able to parse the compressed data and invert coding operations to generate a decompressed representation of the source video. The AOMedia Video 1 protocol (commonly, “AV1”), the ITU-T H.265 specification (commonly, “HEVC”), and the ITU-T H.266 specification (commonly, “VVC”) are examples of these inter-operability coding specifications.

The coding specifications often employ spatial and temporal prediction as one technique to compress video. At a high level, a video encoder compares content from video frames (called “pixel blocks,” for convenience) to video content that has been coded already and decoded. When a match is recognized, the encoder may identify the previously-coded matching pixel block (called, a “reference pixel block,” for convenience) that generates the match, and it may determine whether to code residual data representing a difference between the source pixel block that is being coded and the reference pixel block. When spatial prediction is employed (also called intra coding), the reference pixel block is selected from previously coded content of the frame in which the pixel block that currently is being coded (the “current pixel block”) is located. When temporal prediction is employed (also called inter coding), the reference pixel block is selected from previously-coded content of other frames that already have been processed by the encoder. Modern coding specifications may support several variants of intra coding and several types of inter coding, which will involve processing techniques that are specific to those variants. Typically, each type of coding requires the encoder to provide prediction metadata, including a motion or displacement vector, that identifies a location of the reference pixel block. The decoder uses the prediction metadata to retrieve the reference pixel block from its own copy of decoded video in a decompression operation.

Intra Block Copy (“IBC”) is one type of intra coding. It is intended primarily to improve the compression of intra-coded blocks, and, in particular, screen content. At a high level, IBC coding searches from among previously coded and decoded data of a frame that is currently being coded for matching patterns, then identify matching locations with a displacement or block vector. These vectors are often limited to integer precision i.e., no sub-pixel interpolation is required. IBC can provide more significant coding gains than are provided by other intra coding modes since, in such frames, prediction from previously-coded frames is not allowed. The IBC method is particularly effective in screen content coding, where there are commonly repetitive patterns in the frame, for example textures, letters, icons, buttons, and so forth. Instead of having to code a block containing such patterns with less efficient, regular intra prediction methods that commonly only use already coded neighboring pixels around this block, with IBC, an encoder simply can point to a previously-coded area in the same frame that contains the same or similar pattern, and use that area's content as a predictor for the current block.

Modern video coding formats and standards also include in-loop filtering steps that can alleviate some visual artifacts that may be introduced during the coding process. For example, blockiness, ringing, and banding artifacts may be introduced by different coding processes. In-loop filtering methods can utilize information about how a pixel block and its neighboring pixel blocks were coded, examine the characteristics of neighboring pixels within an area, and then select coding parameters from this analysis to mitigate some of these coding artifacts. Multiple in-loop filtering strategies may be supported within a single coding specification, including filtering for deblocking, deringing, sharpening, etc. Well known loop filters in different standards, other than deblocking, include the sample adaptive offset (SAO) technique, Adaptive Loop Filtering (ALF), the Constrained Directional Enhancement Filter (CDEF), and others.

A major issue that exists with IBC in most implementations, including in AV1, is that it is preferable for implementation reasons to use reconstructed samples for prediction prior to the use of any filtering. It can be challenging to feedback loop-filtered pixels into an encoder's prediction search, since the loop-filter process may be happening significantly later than the encoder's mode decision when a prediction search is performed. Due to this difficulty, the AV1 specification disallows loop filtering for frames that are coded with IBC enabled. As a result of this limitation, the IBC tool can be less effective when used within the AV1 format, especially at lower bitrates, since the lack of deblocking and deringing (CDEF) loop filtering operations may result in significant visual impairments. Subsequent inter frames that might enable loop filters, are often unable to clean up the visual artifacts, which can persist for a long duration.

The HEVC specification allows IBC coding. To avoid this issue, HEVC has every IBC enabled frame stored in two separate buffers when coded. In the first buffer, the current frame is stored without any loop filter operations performed and IBC is applied on this frame, while, in the second buffer, the frame is stored after all loop filtering operations are applied. The drawbacks of this technique include the increase of memory storage, bandwidth, and power consumption, since the same block needs to be stored and maintained in two different buffers. Namely in hardware implementations two write channels are required, and if hardware internal frame compression is required, the performance of the compression engines must be doubled.

Thus, current implementations of IBC coding are sub-optimal.

### BRIEF DESCRIPTION OF THE DRAWINGS

FIG. 1 illustrates a video exchange system according to an aspect of the present disclosure.

FIG. 2 is a functional block diagram of video encoding and decoding systems according to embodiments of the present disclosure.

FIG. 3 illustrates a relationship between a source coding unit and coded coding units according to an embodiment of the present disclosure.

FIG. 4 illustrates a method according to an embodiment of the present disclosure.

FIG. 5 illustrates another method according to an embodiment of the present disclosure.

FIG. 6 illustrates a method according to an embodiment of the present disclosure.

### DETAILED DESCRIPTION

Embodiments of the present disclosure provide techniques to code and decode video content in a resource-conserved manner. In a first embodiment, a single source coding unit may be represented in coding data as a pair of coded coding units. The first coded representation of the coding unit may be coded according to IBC techniques. The IBC-coded coding unit may be decoded to generate decoded but unfiltered video, which may be made available as a prediction reference for later coding and decoding operations. The second coded representation of the coding unit may be coded using the IBC-coded coding unit as a prediction reference. When the second coded representation is decoded, it may be filtered and made available as a prediction reference for the later coding and decoding operations. It is expected that the unfiltered IBC-decoded coding unit and the filtered decoded coding unit may be generated in a pipelined manner that conserves resources in a computer system that are expended to write and read the video to off-processor storage locations. In another embodiment, coding parameters of coded video may be predicted from coding parameters of previously-coded video belonging at locations temporally removed from video that is being decoded.

FIG. 1 illustrates a video exchange system 100 according to an aspect of the present disclosure. The system 100 may include two or more terminals 110, 120 that may exchange video data across a communication network 130. Video data generated at a first terminal 110 may be compressed according to video coding processes, which reduce the video's bandwidth, and may be transmitted to other terminal 120 for decoding and consumption. In the simplified diagram illustrated in FIG. 1, a first terminal 110 may send the video to a second terminal 120. In other applications, however, the first terminal 110 may send the video to multiple terminals (not shown) in parallel. Moreover, other applications may involve multidirectional exchange of video where, for example, the second terminal 120 may generate its own video data, compress it, and send it to the first terminal 110 for consumption. The principles of the present discussion find application in all such use cases.

In the example of FIG. 1, the terminals 110, 120 are illustrated as tablet computers and smartphones, respectively. The principles of the present disclosure may find applications for a diverse array of terminal devices, including for example, computer services, personal computers, desktop computer, laptop computers, personal media devices, set top devices, and media players. The type of terminal device is immaterial to the present discussion unless noted otherwise herein.

Moreover, the principles of the present disclosure may find applications with a wide variety of networks 130. Such networks 130 may include packet-switched and circuit-switched networks, wired and wireless networks, and computer and communications networks. The architecture and topology of the network 130 is immaterial to the present discussion unless noted otherwise herein.

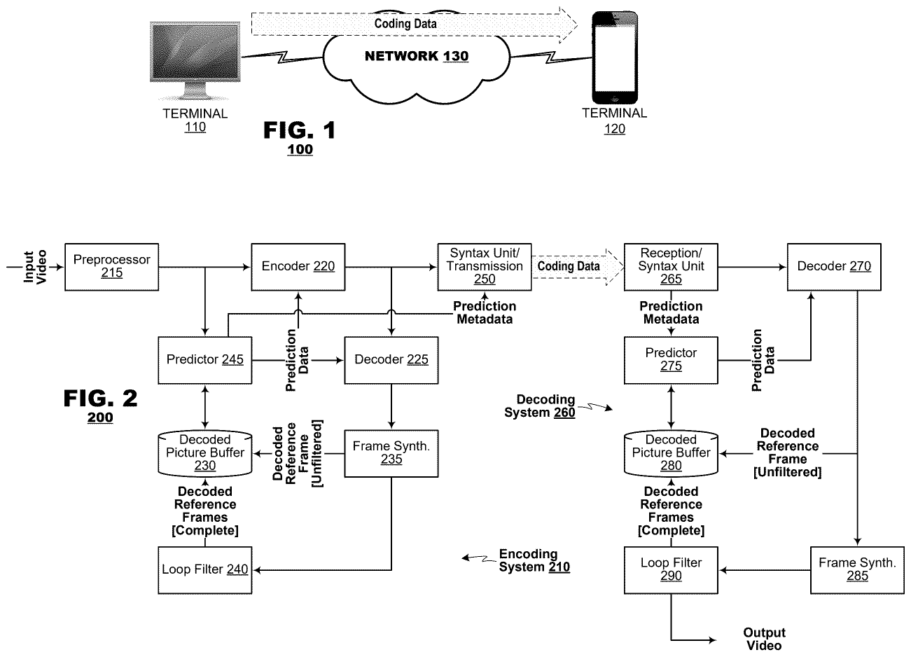

FIG. 2 is a simplified functional block diagram of video encoding and decoding systems 210, 260 according to embodiments of the present disclosure. A video encoding system 210 may include a preprocessor 215, an encoder 220, a decoder 225, a decoded picture buffer 230, a frame synthesizer 235, a filtering unit 240, a predictor 245, and a syntax unit 250. The preprocessor 215 may receive input video and perform preprocessing operations to condition the video for encoding by the encoder 220. For example, the preprocessor 215 may perform frame resizing, spatial resampling, and/or temporal frame rate alterations to the input video. Such operations may be omitted in applications where input video already conforms to the encoder's requirements. The preprocessor 215 also may partition input units into sub-units (called “pixel blocks,” for convenience), that may but need not be uniformly-sized. The partitioning data may be output to the syntax unit 250 (path not shown) for inclusion in coded video data.

The encoder 220 may apply coding operations to the input video to compress its bandwidth. In modern coding applications, for example, those specified by ITU-T coding specifications and elsewhere, encoders 220 often code frames of input video on a pixel block-by-pixel block basis. Content of the pixel blocks may be coded differentially with reference to prediction data (predicted pixel blocks) provided by the predictor 245. The predictor 245 may search a decoded picture buffer 230 for pixel block content that matches a pixel block being coded by the encoder 220 and, when a match is found, the predictor 245 may output the matching pixel block to the encoder 220 and the decoder 225, and it may output prediction metadata to the syntax unit 250 that identifies the matching pixel block identified by its prediction search.

As discussed, modern coding systems support a variety of prediction modes. An intra coding mode searches for prediction matches from among previously coded and decoded video data of a current frame, that is, the frame currently being coded by the encoder 220. In this manner, the pixel block currently being coded by the encoder 220 is coded predictively with reference to other content from the same frame that has already been coded by the encoder. The predictor 245 may provide prediction metadata to a syntax unit 250 that includes a displacement vector identifying a location in the previously decoded frame data where the prediction pixel block may be found.

Inter coding modes search for prediction matches from among previously coded and decoded video data of other frames that already have been coded by the encoding system 210 before the currently-coded frame is presented to the encoding system 210. Modern coding applications support a variety of inter coding modes, including unidirectional prediction, which produces a single prediction pixel block, identifiable by a motion vector and a frame index, and bi-prediction which produces a pair of prediction pixel blocks, identifiable by a pair of motion vectors and reference frame indices, that are combined and provided to the encoder 220. For the intra coding mode, the predictor 245 may provide prediction metadata to a syntax unit 250 that includes a reference index identifying the previously-coded frame(s) that generates the prediction match and motion vector(s) that identify location(s) from the frame(s) from which predicted pixel blocks are to be retrieved.

Following the differential processing associated with the prediction, the encoder 220 determines whether it is appropriate to include a representation of residual data generated from the prediction. A predicted pixel block essentially is subtracted from an input pixel block on a pixel-by-pixel basis, generating pixel residuals. If the block of pixel residuals contains significant content, the encoder 220 may apply further processing to the pixel block, for example, by transforming values of the residual pixel blocks to a transform domain, quantizing coefficients obtained by the transform, and entropy coding the quantized coefficients. These operations generate compressed representations of the input pixel blocks along with other coding metadata (not shown) representing parameters used by the encoder 220. For example, the encoder may select transform types and quantization parameters for use in the transform and quantization operations. The encoder may output the coded pixel block data and coding parameters to the syntax unit 245.

The syntax unit 250 may arrange coded data according to syntax requirements of a governing coding specification. Typically, such coding specifications provide metadata that distinguish different coded entities from each other in the coding data. Thus, the occurrence of frames, slices, tiles, pixel blocks, and other coding entities may be identified by headers or other overhead metadata, which service to identify these entities and distinguish them from each other (e.g., by their type). The IBC coding units and refinement coding units, discussed below, also may be represented in the coding data output by the syntax unit 250 by syntax elements that identify them. The syntax unit 250 may support transmission of the coded video data to a decoding terminal 120 (FIG. 1).

The decoder 225 may invert coding operations performed by the encoder 220 for frames that are designated to serve as reference frames for future prediction operations. For example, the decoder 225 may invert quantization operations, transform operations, and residual processing operations applied to pixel blocks by the encoder 220. The decoder 225 may employ the same quantization parameters and transform type selections that the encoder 220 employed. And the decoder 225 may receive the same prediction pixel blocks from the predictor 240 that the encoder 220 received, applying them in an additive manner to recovered decoded pixel blocks from the residual pixel blocks developed from the quantization and transform operations. Coding processes applied by the encoding system 210 may be lossy processes, and, therefore, the decoded pixel blocks obtained by the decoder 225 likely will resemble their counterpart source pixel blocks as they input to the encoder 210 but the decoded pixel blocks will exhibit some information loss.

As discussed, operations of the encoder 200 and decoder 225 typically operate on a pixel block-by-pixel block basis. An encoding system 210 also may possess a frame synthesizer 235 that assembles frames from the pixel blocks output from the decoder 225 according to the pixel blocks' spatial locations. The frame synthesizer 235 may output decoded frames to the loop filter 240. The frame synthesizer 235 also may store decoded frames assembled from decoded pixel blocks of IBC frames to the decoded picture buffer 230.

The loop filter 240 may perform filtering operations on the frames it receives from the frame synthesizer 235 and may store filtered frames to the decoded picture buffer 230. The loop filter 240 may set filtering parameters based on an analysis of the pixel block's coding modes and coding parameters such as quantization parameters.

A decoding system 260 may possess a syntax unit 265, a decoder 270, a predictor 275, a decoded picture buffer 280, a frame synthesizer 285, and a loop filter 290. The syntax unit 265 may parse coding data into its constituent parts and route the data to other elements of the coding system 260. For example, the syntax unit 265 may route data representing coded pixel blocks to the decoder 270, and it may route prediction metadata to the predictor 275.

The decoder 270 may invert coding of the coded pixel blocks to obtain decoded pixel blocks therefrom. For example, the decoder 270 may invert quantization operations, transform operations, and residual processing operations applied to pixel blocks by the encoder 220. The decoder 275 may employ the same quantization parameters and transform type selections that the encoder 220 employed. And the decoder 275 may receive the same prediction pixel blocks from the predictor 275 that the encoder 220 received, applying them in an additive manner to recovered decoded pixel blocks from the residual pixel blocks developed from the quantization and transform operations. The predictor 275 may retrieve the prediction pixel blocks from the decoded picture buffer 280 based on the prediction metadata received from the syntax unit 265. Again, coding processes applied by the encoding system 210 may be lossy processes, and, therefore, the decoded pixel blocks obtained by the decoder 275 likely will resemble their counterpart source pixel blocks as they input to the encoder 210 but the decoded pixel blocks will exhibit some information loss.

As discussed, the decoder 270 typically operates on a pixel block-by-pixel block basis. A frame synthesizer 285 may assemble frames from the pixel blocks output from the decoder 270 according to the pixel blocks' spatial locations. The frame synthesizer 285 may output decoded frames to the loop filter 290. The frame synthesizer 285 also may store decoded frames assembled from decoded pixel blocks of IBC frames to the decoded picture buffer 280.

The loop filter 290 may perform filtering operations on the frames it receives from the frame synthesizer 285 and may store filtered frames to the decoded picture buffer 280. The loop filter 290 may set filtering parameters based on an analysis of the pixel block's coding modes and coding parameters such as quantization parameters.

Decoded frames may be output from the decoding system 260 after having been filtered by the loop filter 290 or other post-processing system (not shown).

The foregoing description of encoding and decoding system 210, 260 in FIG. 2 illustrates processing that is performed on video as it is input to the encoding system 210, transmitted to a decoding system 260, and decoded. Many encoding and decoding system 210, 260 may process video frames that are too large to store entirely in onboard memory of processing devices. Thus, the decoded picture buffers 230, 280 shown in FIG. 2 may be fulfilled by memory storage systems that are separate from the processing devices on which the processing operations of encoder and decoder systems 210, 260 are implemented. In an embodiment, operation of the functional units in FIG. 2 may be pipelined to conserve processing resources when the encoding and decoding systems 210, 260 are implemented in processing devices.

The functional blocks identified in FIG. 2 support coding, transmission, and decoding of video in a single direction between devices, such as the terminals 110, 120 illustrated in FIG. 1. To support coding, transmission, and decoding of video in a second direction between the terminals 110, 120, a second instance of the encoding system 210 and decoding system 260 may be provided to for this second direction.

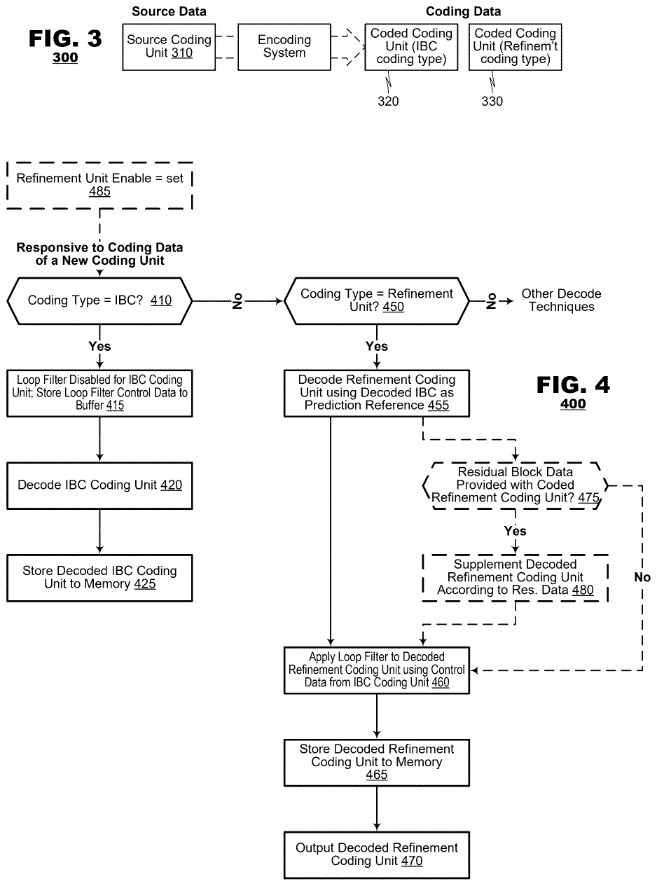

As discussed, embodiments of the present disclosure represent a single coding unit from source video in a coded data stream as a pair of coded coding units. FIG. 3 illustrates a relationship between an exemplary coding unit 310 from source data and coded representations 320, 330 of the coding unit once the coding unit 310 is encoded by an encoding system (FIG. 2). For purposes of the present discussion, a coding unit may be a frame of video, a slice of a frame, or a tile within a frame. Frames, slices, and tiles are constructs defined in various coding protocols. When the source coding unit 310 is coded in this manner, the coded coding units 320, 330 may be represented in the coded data stream separately from each other, with appropriate metadata as defined in the coding protocol to which the encoding system adheres to differentiate the coded coding units 320, 330 from each other. Thus, in an implementation where the source coding unit 310 is a frame of video, the coded coding units 320, 330 both may be represented as coded frames with metadata elements such as headers and coding type metadata as is appropriate under the encoding system's coding protocol. Similarly, when the source coding unit 310 is a slice or a tile, the coded coding units 320, 330 both may be represented as coded slices or coded tiles with metadata elements such as headers and coding type metadata as defined the encoding system's coding protocol.

FIG. 4 illustrates a method 400 according to an embodiment of the present disclosure. The method 400 may be used by a decoder such as those illustrated in FIG. 2. The method 400 may work in the context of a coding protocol by which coding units are represented using a syntax that distinguishes coding units from each other. When a new coding unit is to be processed, the method 400 may determine whether the coding unit is an IBC coded unit (box 410). If so, the method 400 may store filter control data, which is part of a coded bitstream representing the coding unit, in a decoder buffer (box 415). This filter control data may include coding parameters that loop filter control systems typically analyze when setting filter parameters, such as block partitioning and transform information, indications of skipped blocks, indications of blocks with coefficients, quantization parameters (QP), filter strength/mode parameters, motion vector sizes, and the like. The method 400 may decode the coded IBC coding unit according to coded data and coding parameter data available in the bitstream (box 420). In an embodiment, a decoder's loop filter (FIG. 2) may be disabled when decoding the IBC coding unit. The method 400 may store the decoded IBC coding unit to memory (box 425). Once the decoded IBC coding unit is stored to memory, it may be available for use in prediction search.

During processing of boxes 415-425, the coded IBC coding unit may be treated as “no show” data, meaning that it is decoded by the decoder but not output from the decoder. Some coding protocols define a no show parameter, which may be included in coded data of the coding unit to which it applies.

The method 400 may determine whether the new coding unit is a refinement coding unit (box 450). As discussed, the refinement coding unit may be represented in coding data as a separately coded coding unit, for example, by header and/or coding type metadata that distinguishes the coded coding unit from other coded coding units (e.g., the IBC-coded coding unit) in the coding data. If so, the method 400 may decode the coding unit using the decoded coding unit stored in memory at box 425 as a prediction reference (box 455). The method 400 also may apply loop filtering to the decoded refinement coding unit using filter parameters that are derived, at least in part, from filter control data extracted from the coded IBC coding unit (box 460). Thereafter, the method 400 may store the decoded refinement coding unit to memory (box 465) and output the decoded refinement coding unit from the decoder (box 470).

In one embodiment, decoding of the refinement coding unit may occur by copying content from the IBC frame without modification. Essentially, all content for the refinement coding unit would be treated as skip-mode coded content with zero-valued motion vectors. Moreover, the block level syntaxes for the refinement coding unit, including, for example, flags of block partitioning, transform block partitioning, reference frame indices, motion vector/block vector, prediction mode, end-of block (EOB) indicators, transform skip flags, transform type flags, coding block zero residual blocks, need not be signaled in the bitstream; instead they may be derived implicitly for the refinement coding unit from the parameters that are provided with the IBC coding unit.

Optionally, the method 400 may support decoding of coded refinement coding units with coded residual data provided in the coded bitstream. In such embodiments, as part of decoding the coded refinement coding unit (box 455), the method 400 may determine whether coded residual data is provided for the coded refinement coding unit (box 475), and, when residual data is provided, the method 400 may supplement the decoding according to the residual data that is provided (box 480). For example, coding residuals may be decoded by entropy decoding, inverse quantization, and inverse transform processing, then added to a predicted pixel block derived from the IBC coding unit in box 455.

It is expected that coded residual data need not be provided for every pixel block in a coded refinement coding unit. In an embodiment, coded residual coding units may include syntax elements that provide for bandwidth savings when the coded residual coding units are provided only sparsely. For example, a residual coding element may identify a location within the coding unit to which the residual coding element applies by coordinates expressed at pixel block granularities. Pixel block coordinates may be expressed in raster-scan order; thus, a pixel block identified by x=4, y=1 would be located four pixel blocks over and one pixel block down from an origin location of the coding unit. Alternatively, a pixel block's coordinate may be expressed by a run length, which identifies a distance of the residual pixel block from a previously-identified residual pixel block (or, for the first residual pixel block, from the coding unit's origin) according to a raster scan pattern; again, the run length may be expressed at a pixel block granularity. Pixel blocks for which no residual data is supplied may be decoded as described for box 455.

The foregoing discussion describes the method 400 in the context of coding units. The syntax elements of the IBU coding unit and the refinement coding unit may represent the coding units as separately coded entities. The content of the IBC coding unit and the refinement coding unit may represent content of the same coding unit at the same spatial and temporal location as each other. The method 400 may operate at various granularities as may be desired when applying the method 400 to different coding environments. In a simple application, the method 400 may operate at frame granularities where IBC coding units and refinement coding units both are coded frames. In other applications, however, the coding units may correspond to sub-units of frames, for example, slices or tiles. Such sub-units typically are defined by coding protocols to which encoders and decoders adhere; the principles of the present disclosure may be applied to work cooperatively with such protocols.

Operation of the method 400 of FIG. 4 is expected to provide certain benefits when applied to encoder and decoder systems. As discussed, in other applications, it often occurs that the decoding of IBC frames requires two write operations to frame buffer memories to be applied simultaneously. In a hardware implementation, application of predecessor techniques requires parallel writes of two copies of the IBC frame to memory, which requires two communication channels between a processor that performs the decoding operations and a memory that stores the decoded frame data. While the method 400 of FIG. also incurs a pair of write operations to system memory, shown in boxes 425 and 465, these writes can be staggered in time, which allows hardware to provide a single communication channel between a processor and system memory. Thus, use of the method of FIG. 4 is expected to support IBC decode operations with reduced hardware constraints as compared to predecessor solutions.

It further is expected that filter control parameters, when stored as in box 415, will have a smaller representation than decoded coding units and the filter control parameters can be stored in onboard memory of a processing system. Accordingly, storage of filter control parameters to buffer memory and retrieval of those filter control parameters from buffer memory may be performed without incurring processing costs for write and reads from system memory as may occur for decoded coding units.

As shown above, the method 400 causes filtering control parameters of a first coding unit (the IBC coding unit) to control operation of a loop filter during processing of another second coding unit (the refinement coding unit) that appears later in syntax order. Unlike existing designs where loop filtering in a coding unit is controlled only by the coding modes designated for that coding unit, loop filtering operations in the present embodiments may account for coding artifacts that are introduced by a prior coding unit. Thus, a loop filtering system may set filter parameters for a current coding unit based on an analysis of coding mode and quantization information from the previous coding unit and/or basic default processing operations are defined for potentially all blocks in a coding unit. Loop filtering operations could be signaled altogether for an entire coding unit, or they could be signaled individually for pixel blocks within the coding unit. In this manner, a decoder could fully or selectively apply loop filters to a previously coded IBC coding unit. This may allow for fixing or mitigating visual artifacts that may be present in that coding unit and prior to its subsequent use as a reference or output for display.

In an embodiment, at box 415, instead of storing “raw” data extracted directly from the coded IBC coding unit, the method 400 may generate filter parameters, such as deblocking filter strength values along 4×4 boundaries within a spatial area occupied by the IBC coding unit, and store the filter parameters in memory. Doing so may conserve memory resources and consume less bandwidth in a processing system. During loop filtering of the refinement coding unit (box 460), the stored filter controls may be applied directly to a decoder's loop filters without further processing. In another embodiment, the frame control parameters, whether taken “raw” from coding data or converted to filter parameters, may be compressed before storage and decompressed when they are retrieved from storage for use.

It is expected that, in one embodiment, a decoder's loop filter will be disabled while decode of a coded IBC coding unit is performed. The principles of the present disclosure permit a partial disabling of a decoder's loop filter in certain embodiments. In application, decoder hardware may have processing time that allows the decoder to apply certain loop filter operations before a processor's prediction search will be performed using the decoded IBC coding unit as a candidate prediction reference. For example, oftentimes, pixel block level filtering processes that operate on reconstructed pixel blocks employ filtering operations that are performed with relatively simple arithmetic operations such as a linear loop filter with small filter shapes and relatively small filter coefficients; such operations may be employed prior to making a decoded IBC coding unit available for prediction. In another example, a deblocking filtering process that modifies samples of reconstructed pixel blocks along top and left boundaries of the pixel blocks may be performed. In application, the decision of which filtering operations may be performed prior to storing a decoded IBC coding unit may be determined based on the estimated complexity of those filtering operations and an estimate of whether those operations can be performed without interfering with timing of prediction search operations that will be performed using the decoded IBC coding unit. Other filtering operations may be deferred until loop filter processor is performed on a decoded refinement coding unit (box 460).

When applying the principles of FIG. 4, the IBC coding unit and the refinement coding unit may represent coded content at the same spatial and temporal location. The IBC coding unit may be identified by setting a coding type parameter (shown as “coding type”) in the coded data representing the coding unit to identify its coding mode as an IBC coding unit and to distinguish other candidate intra and inter coding modes. Similarly, the refinement coding unit may be identified by setting the coding type parameter in its coded data to identify the coding unit as a refinement coding unit. In an embodiment, it may be convenient to require an encoder to place the refinement coding unit that relies on the coded IBC coding unit as a prediction reference as the next coded coding unit in syntax order. In such an embodiment, the coding type parameter may be omitted in the coded data of the refinement coding unit; the decoder may infer the refinement coding unit's coding type from its location in the coding syntax with reference to the IBC coding unit.

As discussed, processing of boxes 415-425 may cause the IBC coding unit to be decoded and stored to memory but not output from the decoder for display or other consumption. In some embodiments, a decoder may determine that the decoded IBC coding unit is not to be displayed from the coding unit's coding type as represented in coding data; that is, all coded IBC coding units may be designated not to be displayed. Other embodiments (discussed below) may allow a decoded IBC coding unit to be output from a decoder. Thus, some other embodiments may set a show/no show parameter in coded data of the IBC coding unit that indicate whether the decoded IBC coding unit may be output from the decoder. In circumstances where the parameter is set to “no show,” the method 400 may store the decoded IBC coding unit to memory (box 425) without outputting it from the decoder. In circumstances where the parameter is set to “show,” the method 400 may store the decoded IBC coding unit to memory (box 425) and output it from the decoder (not shown).

In an embodiment, when storing a decoded refinement coding unit to memory (box 465), the method 400 may overwrite the stored decoded IBC coding unit with the decoded refinement coding unit. In other embodiments, the decoded IBC coding unit may be preserved in memory (the decoded refinement coding unit may be stored in a different memory location) in response to a command placed in coded video data. Preserving the decoded IBC coding unit in memory allows an encoder to intra-code a new frame where both the decoded IBC coding unit and the decoded reference frame coding unit are available as candidates for prediction.

In an embodiment, the presence of IBC coding units and refinement coding units in a coded bitstream may be signaled in a coding syntax, for example, by setting a parameter that indicates refinement unit processing is enabled (box 485). Many coding protocols employ hierarchical coding syntaxes, which allows video encoders to define parameters at a first level in the hierarchy that apply to lower levels of the hierarchy. For example, a video encoder may define parameters for a sequence that includes multiple frames (often in a sequence parameter set), for a video frame (often in a picture parameter set), for slices, tiles, and other hierarchical levels. In such applications, an encoder may indicate that refinement coding units are enabled at a sequence level to enable refinement processing for all frames in a sequence, at a picture level to enable refinement processing for all pixel blocks in a frame, at a slice level to enable refinement processing for all pixel blocks in a slice, and at a tile level to enable refinement processing for all pixel blocks in a tile. Setting the refinement coding units as enabled or disabled at level hierarchical levels can lead to resource conservation because, when refinement unit processing is disabled, resources need not be expended to determine whether refinement coding units have been included in coded video data and memory resources need not be allocated to preserve loop filter control data from one coding unit to the next.

In another embodiment, parameters for loop filtering operations may specified through syntax elements that are provided in a frame footer/extension structure of the syntax. For example, the syntax may follow a hierarchy such as:

```
frame_obu( ) {
  frame_header( )
  tile_structures( )
  frame_footer( )
}
```

In this embodiment, a footer structure provides for the indication of control parameters, such as filtering parameters, that apply to a decoding process. The structure is a footer because it appears in a coding bitstream after other syntax information needed for the reconstruction of the frame is provided. It allows for data in the footer to be accessed in reverse from a terminal end of the structure.

In another embodiment, frame_footer( ) information may be added as an independent Object Based Unit (“OBU,” in AV1) or Network Abstraction Layer (“NAL”, in HEVC) unit type that will be expected to follow other OBU or NAL unit types that correspond to the current frame. The frame_footer structure could contain coding unit but also optionally pixel block level loop filtering control parameters that could be applied to the decoded coding unit after its complete reconstruction and prior to that coding unit being stored in memory. Alternatively, a decoder could also operate using two reconstruction buffers, one that does not utilize the loop filtering information present in the frame_footer( ) that is used for all reconstruction processes (including IBC operations) and a second buffer that accounts for such information to perform loop filtering. At the end of the process, the second buffer (with loop filtering) may be retained, or both buffers may be retained for future operations. Retaining one or both buffers could be indicated through syntax information included in the frame_footer( ).

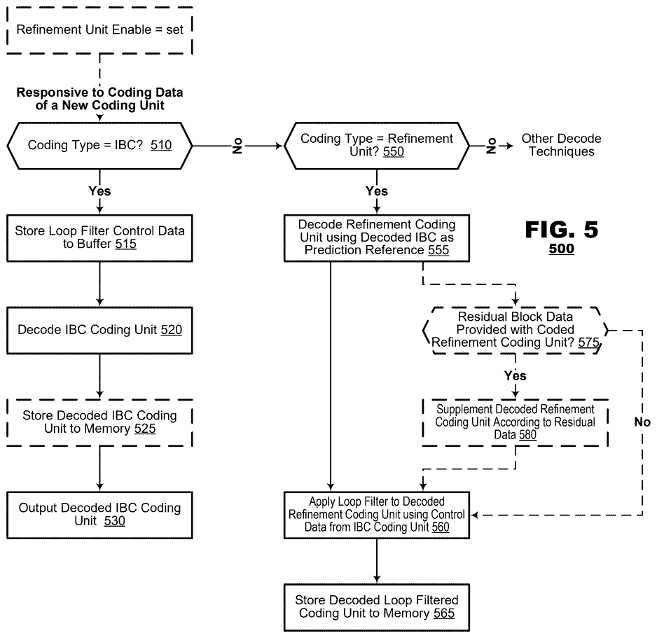

FIG. 5 illustrates another method 500 according to an embodiment of the present disclosure. The method 500 may be used by a decoder such as those of FIG. 2. The method 500 may work in the context of a coding protocol by which coding units are represented. For purposes of the present discussion, the coding units may be a frame of video, a slice of a frame, or a tile within a frame. Frames, slices, and tiles are constructs defined in various coding protocols.

When a new coding unit is to be processed, the method 500 may determine whether the coding unit is an IBC coded unit (box 510). If so, the method 500 may store filter control data, which is received in a coded bitstream for the coding unit, in a decoder buffer (box 515). This filter control data may include coding parameters that loop filter control systems typically analyze when setting filter parameters, such as block partitioning and transform information, indications of skipped blocks, indications of blocks with coefficients, quantization parameters (QP), filter strength/mode parameters, motion vector sizes, and the like. The method 500 may decode the coded IBC coding unit according to coded data and coding parameter data available in the bitstream (box 520). In an embodiment, a decoder's loop filter may be disabled when decoding the IBC coding unit. The method 500 may store the decoded IBC coding unit to memory (box 525). Once the decoded IBC coding unit is stored to memory, it may be available for use in prediction search. Further, the decoded IBC coding unit may be output from the decoder (box 530).

The method 500 may determine whether the new coding unit is a refinement coding unit (box 550). If so, the method 500 may decode the coding unit using the decoded coding unit stored in memory at box 525 as a prediction reference (box 555). The method 500 also may apply loop filtering to the decoded refinement coding unit using filter parameters that are derived, at least in part, from filter control data extracted from the coded IBC coding unit (box 560). Thereafter, the method 500 may store the decoded refinement coding unit to memory (box 565).

In one embodiment, decoding of the refinement coding unit may occur by copying content from the IBC frame without modification. Essentially, all content for the refinement coding unit would be treated as skip-mode coded content with zero-valued motion vectors. Moreover, the block level syntaxes for the refinement coding unit, including, for example, flags of block partitioning, transform block partitioning, reference frame indices, motion vector/block vector, prediction mode, end-of block (EOB) indicators, transform skip flags, transform type flags, coding block zero residual blocks, need not be signaled in the bitstream; instead they may be derived implicitly for the refinement coding unit from the parameters that are provided with the IBC coding unit.

Optionally, the method 500 may support decoding of coded refinement coding units with coded residual data provided in the coded bitstream. In such embodiments, as part of decoding the coded refinement coding unit (box 555), the method may determine whether coded residual data is provided for the coded refinement coding unit (box 575), and, when residual data is provided, the method may supplement the decoding according to the residual data that is provided (box 580). For example, coding residuals may be decoded by entropy decoding, inverse quantization, and inverse transform processing, then added to a predicted pixel block derived from the IBC coding unit in box 555.

In the embodiment of FIG. 5, it is the unfiltered decoded IBC coding unit that is output from the decoder for consumption, for example, by display or processing by another application executing on the device (not shown in FIG. 1). The filtered refinement coding unit may be stored in memory and made available for prediction searches. In this embodiment, both unfiltered and filtered variants of the coding unit, which are stored respectively at boxes 525 and 565 may be made available as prediction references for later coding operations.

The variants discussed hereinabove with respect to FIG. 3 also may find application in the method 500 of FIG. 5.

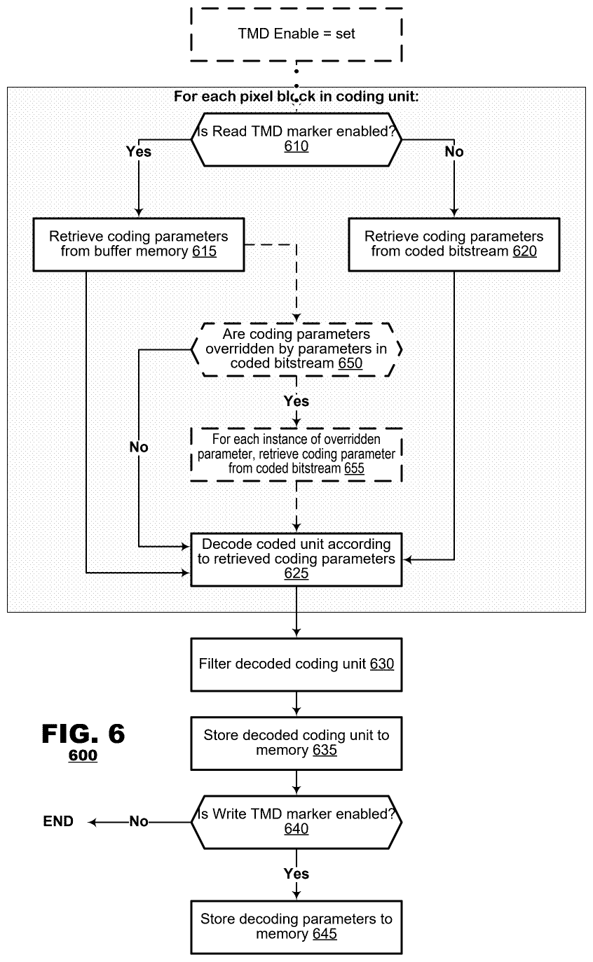

FIG. 6 illustrates a method 600 according to an embodiment of the present disclosure. The method 600 may be used by a decoder such as those illustrated in FIG. 2. In this embodiment a decoder may derive coding parameters of a pixel block from parameters of a co-located pixel block of a previously-coded frame. The method of FIG. 6 may operate on coded coding units identified in a coded bitstream, such a coded frames, coded slices and/or coded tiles. Because coding parameters are developed from parameters of blocks at other temporal locations, the derived parameters are called “Temporal Mode Decision” parameters (or TMD parameters), for convenience.

When a decoder processes a new coding unit from the coded bitstream, it may determine for each pixel block in the coding unit, whether a read TMD marker is enabled (box 610). The read TMD marker may be a syntax element providing within coding data of a coding unit that indicates whether coding parameters for decoding a pixel block are to be derived from a previously-coded pixel block or not. When the read TMD marker is enabled, the method may retrieve coding parameters from buffer memory associated with a co-located pixel block in a previously-decoded frame (box 615). The coding parameters may indicate parameters to be used in decoding the pixel block, for example, a transform type, a prediction mode, whether transform coefficients are present, the transform coefficients themselves, quantization parameters, block partitioning and transform partitioning trees and the like. When the read TMD marker is not enabled, the method 600 may retrieve the coding parameters from the coded bitstream (box 620) or determine them from some other source. Thereafter, the method 600 may decode the coding unit according to the retrieved coding parameters (box 625). The operations of boxes 610-625 may repeat for as many pixel blocks as are included in the coding unit.

When decoding of the pixel blocks is complete, the method 600 may perform other processing operations on the coding unit, such as in loop filtering, using coding parameters derived in box 615 or 620 (box 630). The method 600 may store the decoded coding unit to memory (box 635) and output the decoded coding unit from the decoder.

Once decoding and processing of the coding unit is complete, the method 600 may determine whether a write TMD marker is enabled for the coding unit (box 640). The write TMD marker may be a syntax element that indicates whether coding parameters the decoded pixel block are to be stored for reference in future iterations of the method 600 when pixel blocks of later-coded frames are decoded. If the write TMD marker is enabled, the method 600 may store coding parameters for the decoded coding unit in memory (box 645). For example, coding parameters for a current frame may be retrieved in box 615 when processing a later-received coding unit. If the write TMD parameter is not enabled, then the method 600 may end. Read TMD and write TMD parameters may use independently of each other. That is, a coding unit that has a read TMD parameter set for it may but need not have a write TMD parameter set for it. Similarly, a coding unit that has a write TMD parameter set for it may but need not have a read TMD parameter set for it.

Embodiments of the present invention also support a hybrid approach between the techniques illustrated in boxes 615 and 620. For example, coding data for a pixel block may indicate that a read TMD parameter is set for the pixel block and the coding data also may explicitly provide selections of a sub-set of coding parameters that may be retrieved from the buffer memory in box 615. In this circumstance, the method 600 may determine that select decoding parameters that are retrieved from memory in box 615 are to be overridden by the coding parameters provided in the coded pixel block data in the bitstream (box 650). Each instance of coding parameter data provided in the bitstream overrides its counterpart coding parameter that is retrieved from memory (box 655). Under this embodiment, it is expected that the volume of overriding coding parameters provided in a coded bitstream will be sparse as compared to the volume of coding parameters retrieved from memory in box 615 and, therefore, application of the method 600 will lead to resource conservation in a coding system.

The method 600 of FIG. 6 is described with read TMD parameters and write TMD parameters set individually for each pixel block in a coding unit. In another embodiment, the read TMD parameters and write TMD parameters may be set globally for all pixel blocks in a coding unit. Varying the hierarchical level at which the read TMD parameters and write TMD parameters are set provides variable control over the granularity at which the method 600 operates.

And, of course, in another embodiment, the read TMD parameters and write TMD parameters may be set at multiple hierarchical levels within a coding syntax. Providing read TMD parameters and write TMD parameters at a first level in the hierarchy, for example, may set default settings for all pixel blocks contained below that first level; those default settings may be overridden for pixel blocks below that first level by providing read TMD parameters and write TMD parameters for those pixel blocks at a second, lower-level of the hierarchy. For example, when read TMD parameters and/or write TMD parameters are omitted from pixel blocks, the method 600 of FIG. 6 may operate using the read TMD parameters and write TMD parameters set at a higher hierarchical level in the coding syntax. When read TMD parameters and/or write TMD parameters are provided for individual pixel blocks, the method 600 of FIG. 6 may operate using the TMD parameters so provided.

In an embodiment, a decoder may maintain multiple sets N of coding parameters in memory. A coded bitstream may provide an index into the N sets of coding parameters with the read TMD parameters, which identifies the set of parameters that is to be retrieved in box 615 and applied to the pixel blocks for which the index was provided.

The foregoing discussion has described operation of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically are stored in physical storage media such as electronic-, magnetic-, and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

Video coders and decoders may exchange video through channels in a variety of ways. They may communicate with each other via communication and/or computer networks as illustrated in FIG. 1. In still other applications, video coders may output video data to storage devices, such as electrical, magnetic and/or optical storage media, which may be provided to decoders sometime later. In such applications, the decoders may retrieve the coded video data from the storage devices and decode it.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A video coding method, comprising,
responsive to coding data representing a first coding unit coded according to intra-block copy techniques,
decoding the coded first coding unit according to intra-block copy techniques,
storing the decoded first coding unit in a manner that makes the decoded coding unit available for use as a prediction reference by a predictive coder,
responsive to received coding data representing a second coding unit coded using the first coding unit as a prediction reference:
decoding the second coding unit,
filtering the decoded second coding unit according to filter parameter control data provided in the coding data of the first coding unit.

2. The method of claim 1, further comprising storing the filtered, decoded second coding unit in a manner that makes the filtered, decoded second coding unit available for use as a prediction reference by the predictive coder.

3. The method of claim 1, wherein the first and second coding units both represent common image information at a common temporal instant.

4. The method of claim 1, wherein the first and second coding units both are identified in the coding data with separate syntactic elements.

5. The method of claim 1, wherein the decoding of the second coding unit is performed by copying decoded content of the first coding unit.

6. The method of claim 1, wherein the decoding of the second coding unit is performed by copying decoded content of the first coding unit and supplementing the decoded content of the first coding unit based on coded residual data provided in the coding data.

7. The method of claim 1, wherein the decoded first coding unit and the filtered, decoded IBC second coding both are stored in a memory system separate from a processor on which the decoding steps are performed.

8. The method of claim 1, further comprising, when the storing the filtered, decoded second coding unit is performed, evicting the decoded first coding unit from a memory in which the decoded first coding unit was stored.

9. The method of claim 1, wherein, upon storing the filtered decoded refinement coding unit both the stored decoded IBC coding unit and the stored filtered decoded refinement coding unit are available as prediction references in a subsequent decoding operation.

10. The method of claim 1, wherein the stored decoded IBC coding unit is not filtered prior to the storing.

11. The method of claim 1, wherein the first coding unit represents a coded frame of image data.

12. The method of claim 1, wherein the first coding unit represents a coded tile of image data.

13. The method of claim 1, wherein the first coding unit represents a coded slice of image data.

14. The method of claim 1, further comprising outputting the unfiltered decoded first coding unit data as output from a decoder.

15. The method of claim 1, further comprising outputting the filtered decoded second coding unit data as output from a decoder.

16. A computer readable medium storing program instructions that, when executed by a processing device, cause the processing device to:
responsive to coding data representing a first coding unit coded according to intra-block copy techniques,
decoding the coded first coding unit according to intra-block copy techniques,
storing the decoded first coding unit in a manner that makes the decoded coding unit available for use as a prediction reference by a predictive coder,
responsive to coding data representing a second coding unit coded using the first coding unit as a prediction reference:
decoding the second coding unit,
filtering the decoded second coding unit according to filter parameter control data provided in the coding data of the first coding unit, and
storing the filtered, decoded second coding unit in a manner that makes the filtered, decoded second coding unit available for use as a prediction reference by the predictive coder.

17. The medium of claim 16, wherein the processing instructions cause the processor to store the decoded IBC coding unit in a location of system memory.

18. The medium of claim 16, wherein the processing instructions cause the processor to store the decoded refinement coding unit in a location of system memory.

19. The medium of claim 16, wherein the processing instructions cause the processor to store the filter parameter control data contained in the received data associated with the intra-block copy coding unit in buffer memory of the processor.

20. A video coding method, comprising,
responsive to coding data representing a first coding unit coded according to intra-block copy techniques, decoding the coded first coding unit according to intra-block copy techniques,
responsive to coding received data representing a second coding unit coded using the first coding unit as a prediction reference:
decoding the second coding unit,
filtering the decoded second coding unit according to filter parameter control data provided in the coding data of the first coding unit, and
storing at least one of the decoded first coding unit and the decoded second coding unit in a manner that makes the decoded coding unit available for use as a prediction reference by a predictive coder.

21. A decoding method comprising:
based on a representation of a coded pixel block for a first coding unit, determining whether to predict coding parameters of the pixel block from coding parameters of a pixel block of a previously-coded coding unit,
based on the determination, performing one of:
deriving coding parameters from coding parameters of the pixel block of the previously-coded coding unit,
deriving coding parameters from coding parameters of the pixel block from coded data of the pixel block, and
decoding the pixel block according to the derived coding parameters.

22. The method of claim 20, further comprising, when a parameter provided in coded data of the first coding unit indicates that the derived coding parameters of the pixel block are to serve as a candidate prediction reference for a later-coded coding unit, storing the derived coding parameters.

23. The method of claim 20, wherein the first coding unit is a frame of image data.

24. The method of claim 20, wherein the first coding unit is a tile of image data.

25. The method of claim 20, wherein the first coding unit is a slice of image data.

26. A computer readable medium storing program instructions that, when executed by a processing device, cause the processing device to:
based on a representation of a coded pixel block for a first coding unit, determine whether to predict coding parameters of the pixel block from coding parameters of a pixel block of a previously-coded coding unit,
based on the determination, perform one of:
deriving coding parameters from coding parameters of the pixel block of the previously-coded coding unit,
deriving coding parameters from coding parameters of the pixel block from coded data of the pixel block, and
decode the pixel block according to the derived coding parameters.
